(19) United States
(12) Patent Application Publication
(10) Pub. No.: US 2020/0001880 A1
(43) Pub. Date: Jan. 2, 2020

(54) DRIVER STATE ESTIMATION DEVICE AND DRIVER STATE ESTIMATION METHOD

(71) Applicant: OMRON Corporation, Kyoto-shi, KYOTO (JP)

(72) Inventors: Tadashi HYUGA, Hirakata-shi (JP); Masaki SUWA, Kyoto-shi (JP); Koichi KINOSHITA, Kyoto-shi (JP)

(73) Assignee: OMRON Corporation, Kyoto-shi, KYOTO (JP)

(21) Appl. No.: 16/482,284

(22) PCT Filed: Jul. 27, 2017
(86) PCT No.: PCT/JP2017/027246

§ 371 Date: Jul. 31, 2019

(30) Foreign Application Priority Data
Mar. 14, 2017 (JP) 2017-048504

(51) Int. Cl. B60W 40/08; G06T 7/73; G06K 9/00; B60K 28/02

(52) U.S. Cl. CPC B60W 40/08; G06T 7/73; G06T 2207/30201; B60K 28/02; G06K 9/00268

(57) ABSTRACT

A driver state estimation device which can estimate a distance to a driver's head position without detecting a center position of the driver's face area in an image, includes a camera, a lighting part, and a CPU including a face detecting section for detecting the driver's face in a first image picked up at the time of light irradiation from the lighting part and in a second image picked up at the time of no light irradiation from the lighting part, a face brightness ratio calculating section for calculating a brightness ratio between the driver's face in the first image and that in the second image, and a distance estimating section for estimating a distance from the driver's head to the camera using the calculated face brightness ratio.

### TECHNICAL FIELD

The present invention relates to a driver state estimation device and a driver state estimation method, and more particularly, to a driver state estimation device and a driver state estimation method, whereby a state of a driver can be estimated using picked-up images.

### BACKGROUND ART

Techniques of detecting a state of a driver's motion or line of sight using images of the driver taken by an in-vehicle camera so as to present information required by the driver or give an alarm have been developed through the years.

In an automatic vehicle operation system the development of which has been recently promoted, it is considered that a technique of continuously estimating whether a driver is in a state of being able to conduct a driving operation comes to be necessary even during an automatic vehicle operation, for smooth switching from the automatic vehicle operation to a manual vehicle operation. The development of techniques of analyzing images picked up by an in-vehicle camera to estimate a state of a driver is proceeding.

In order to estimate the state of the driver, techniques of detecting a head position of the driver are required. For example, in Patent Document 1, a technique wherein a face area of a driver in an image picked up by an in-vehicle camera is detected, and on the basis of the detected face area, a head position of the driver is estimated, is disclosed.

In the above method for estimating the head position of the driver, specifically, an angle of the head position with respect to the in-vehicle camera is detected. As a method for detecting the angle of the head position, a center position of the face area on the image is detected. Regarding the detected center position of the face area as the head position, a head position line which passes through the center position of the face area is obtained, and an angle of the head position line (the angle of the head position with respect to the in-vehicle camera) is determined.

Thereafter, a head position on the head position line is detected. As a method for detecting the head position on the head position line, a standard size of the face area in the case of being a prescribed distance away from the in-vehicle camera is previously stored. By comparing this standard size to the size of the actually detected face area, a distance from the in-vehicle camera to the head position is obtained. A position on the head position line away from the in-vehicle camera by the obtained distance is estimated to be the head position.

### Problems to be Solved by the Invention

In the method for estimating the head position described in Patent Document 1, the head position on the image is detected with reference to the center position of the face area. However, the center position of the face area varies according to a face direction. Therefore, even in cases where the head position is at the same position, with different face directions, the center position of the face area detected on each image is detected at a different position. As a result, the head position on the image is detected at a position different from the head position in the real world, that is, the distance to the head position in the real world cannot be accurately estimated.

### PRIOR ART DOCUMENT

### Patent Document

Patent Document 1: Japanese Patent Application Laid-Open Publication No. 2014-218140

### SUMMARY OF THE INVENTION

### Means for Solving Problem and the Effect

The present invention was developed in order to solve the above problem, and it is an object of the present invention to provide a driver state estimation device and a driver state estimation method, whereby a distance to a head of a driver can be estimated without detecting a center position of a face area of the driver in an image, and the estimated distance can be used for deciding a state of the driver.

In order to achieve the above object, a driver state estimation device according to a first aspect of the present invention is characterized by estimating a state of a driver using picked-up images, the driver state estimation device comprising:

an imaging section for imaging a driver sitting in a driver's seat;

a lighting part for irradiating a face of the driver with light; and

at least one hardware processor,

the at least one hardware processor comprising

a face detecting section for detecting the face of the driver in a first image picked up by the imaging section at the time of light irradiation from the lighting part and in a second image picked up by the imaging section at the time of no light irradiation from the lighting part,

a face brightness ratio calculating section for calculating a brightness ratio between the face of the driver in the first image and the face of the driver in the second image, detected by the face detecting section, and

a distance estimating section for estimating a distance from a head of the driver sitting in the driver's seat to the imaging section with use of the face brightness ratio calculated by the face brightness ratio calculating section.

Using the driver state estimation device according to the first aspect of the present invention, the face of the driver is detected each in the first image and in the second image, the brightness ratio between the detected face of the driver in the first image and that in the second image is calculated, and the distance from the head of the driver sitting in the driver's seat to the imaging section is estimated with use of the calculated face brightness ratio. Consequently, without obtaining a center position of the face area in the image, the distance can be estimated based on the face brightness ratio between the face of the driver in the first image and that in the second image. Using the estimated distance, it becomes possible to estimate a state such as a position and attitude of the driver sitting in the driver's seat.

The driver state estimation device according to a second aspect of the present invention is characterized by comprising a table information storing part for storing one or more tables for distance estimation showing a correlation between the face brightness ratio and the distance from the head of the driver sitting in the driver's seat to the imaging section,

the at least one hardware processor comprising

a table selecting section for selecting a table for distance estimation corresponding to the brightness of the face of the driver in the second image from the one or more tables for distance estimation stored in the table information storing part, wherein

the distance estimating section compares the face brightness ratio calculated by the face brightness ratio calculating section with the table for distance estimation selected by the table selecting section to estimate the distance from the head of the driver sitting in the driver's seat to the imaging section in the driver state estimation device according to the first aspect of the present invention.

Using the driver state estimation device according to the second aspect of the present invention, one or more tables for distance estimation showing the correlation between the face brightness ratio and the distance from the head of the driver to the imaging section are stored in the table information storing part, and the face brightness ratio calculated by the face brightness ratio calculating section is compared with the table for distance estimation selected by the table selecting section to estimate the distance from the head of the driver sitting in the driver's seat to the imaging section.

The reflection intensity of light irradiated from the lighting part varies depending on the brightness of the face of the driver. However, by selecting and using the table for distance estimation showing the relationship of the reflection intensity suitable for the brightness of the face of the driver, the estimation accuracy of the distance from the head of the driver to the imaging section can be enhanced. Furthermore, by using the table for distance estimation, the processing can be speedily conducted without applying a load to the processing of distance estimation.

The driver state estimation device according to a third aspect of the present invention is characterized by the at least one hardware processor comprising

an attribute deciding section for deciding attributes of the driver using the image of the face of the driver detected by the face detecting section, wherein

the one or more tables for distance estimation include a table for distance estimation corresponding to the attributes of the driver, and

the table selecting section selects the table for distance estimation corresponding to the attributes of the driver decided by the attribute deciding section from the one or more tables for distance estimation in the driver state estimation device according to the second aspect of the present invention.

Using the driver state estimation device according to the third aspect of the present invention, the attributes of the driver are decided using the image of the face of the driver detected by the face detecting section, and the table for distance estimation corresponding to the attributes of the driver decided by the attribute deciding section is selected from the one or more tables for distance estimation. Consequently, the table for distance estimation corresponding to not only the brightness of the face of the driver in the second image but also the attributes of the driver can be selected and used, leading to a further enhanced accuracy of the distance estimated by the distance estimating section.

The driver state estimation device according to a fourth aspect of the present invention is characterized by the attributes of the driver which include at least one of the race, sex, wearing or not wearing makeup, and age in the driver state estimation device according to the third aspect of the present invention.

Using the driver state estimation device according to the fourth aspect of the present invention, in the attributes of the driver, at least one of the race, sex, wearing or not wearing makeup, and age is included. Therefore, by preparing the tables for distance estimation according to various kinds of attributes of the driver to be selectable, the accuracy of the distance estimated by the distance estimating section can be further enhanced.

The driver state estimation device according to a fifth aspect of the present invention is characterized by the at least one hardware processor comprising

an illuminance data acquiring section for acquiring illuminance data from an illuminance detecting section for detecting an illuminance outside the vehicle, wherein

the table selecting section selects the table for distance estimation corresponding to the brightness of the face of the driver in the second image in consideration of the illuminance data acquired by the illuminance data acquiring section in the driver state estimation device according to the second aspect of the present invention.

In on-board circumstances, a situation where the brightness of the face of the driver and the brightness of the surroundings are extremely different can be caused depending on the light radiation direction from the sun, or the road situation such as the entrance or exit of a tunnel. In such cases, the brightness of the face of the driver in the second image is affected.

Using the driver state estimation device according to the fifth aspect of the present invention, in consideration of the illuminance data acquired by the illuminance data acquiring section, the table for distance estimation corresponding to the brightness of the face of the driver in the second image is selected. Consequently, it is possible to select an appropriate table for distance estimation with consideration given to the illuminance outside the vehicle at the time of picking up the second image, leading to reduced variations in the accuracy of the distance estimated by the distance estimating section.

The driver state estimation device according to a sixth aspect of the present invention is characterized by the at least one hardware processor comprising

a driving operation possibility deciding section for deciding whether the driver sitting in the driver's seat is in a state of being able to conduct a driving operation with use of the distance estimated by the distance estimating section in the driver state estimation device according to any one of the first to fifth aspects of the present invention.

Using the driver state estimation device according to the sixth aspect of the present invention, with use of the distance estimated by the distance estimating section, whether the driver sitting in the driver's seat is in the state of being able to conduct a driving operation can be decided, leading to appropriate monitoring of the driver.

A driver state estimation method according to the present invention is characterized by estimating a state of a driver sitting in a driver's seat, using a device comprising an imaging section for imaging the driver sitting in the driver's seat, a lighting part for irradiating a face of the driver with light, and at least one hardware processor, wherein

the at least one hardware processor conducts the steps comprising:

detecting the face of the driver in a first image picked up by the imaging section at the time of light irradiation on the face of the driver from the lighting part and in a second image picked up by the imaging section at the time of no light irradiation on the face of the driver from the lighting part;

calculating a face brightness ratio between the face of the driver in the first image and the face of the driver in the second image, detected in the step of detecting the face; and

estimating a distance from a head of the driver sitting in the driver's seat to the imaging section with use of the face brightness ratio calculated in the step of calculating the face brightness ratio.

Using the above driver state estimation method, in each of the first image and the second image, the face of the driver is detected, the brightness ratio between the face of the driver detected in the first image and the face of the driver detected in the second image is calculated, and with use of the face brightness ratio, the distance from the head of the driver sitting in the driver's seat to the imaging section is estimated. Consequently, without obtaining a center position of the face area in the image, the distance can be estimated based on the brightness ratio between the face of the driver in the first image and the face of the driver in the second image. Using the estimated distance, it becomes possible to estimate a state such as a position and attitude of the driver sitting in the driver's seat.

### BRIEF DESCRIPTION OF DRAWINGS

FIG. 1 is a block diagram schematically showing the principal part of an automatic vehicle operation system including a driver state estimation device according to an embodiment (1) of the present invention;

FIG. 2 is a block diagram showing a construction of the driver state estimation device according to the embodiment (1);

FIG. 3(a) is a plan view of a car room showing an installation example of a monocular camera, FIG. 3(b) is an illustration showing an image example picked up by the monocular camera, and FIG. 3(c) is a timing chart showing an example of picking-up timing of the monocular camera and on/off switching timing of a lighting part;

FIG. 4(a) is a diagram showing an example of a table for distance estimation stored in a table information storing part, and FIG. 4(b) is a graphical representation for explaining some sorts of tables for distance estimation;

FIG. 5 is a flowchart showing processing operations conducted by a CPU in the driver state estimation device according to the embodiment (1);

FIG. 6 is a block diagram showing a construction of a driver state estimation device according to an embodiment (2);

FIG. 7 is a diagram for explaining attributes of a driver decided by an attribute deciding section and tables for distance estimation stored in a table information storing part;

FIG. 8 is a flowchart showing processing operations conducted by a CPU in the driver state estimation device according to the embodiment (2); and

FIG. 9 is a block diagram showing a construction of a driver state estimation device according to an embodiment (3).

### MODE FOR CARRYING OUT THE INVENTION

The embodiments of the driver state estimation device and the driver state estimation method according to the present invention are described below by reference to the Figures. The below-described embodiments are preferred embodiments of the present invention, and various technical limitations are included. However, the scope of the present invention is not limited to these modes, as far as there is no description particularly limiting the present invention in the following explanations.

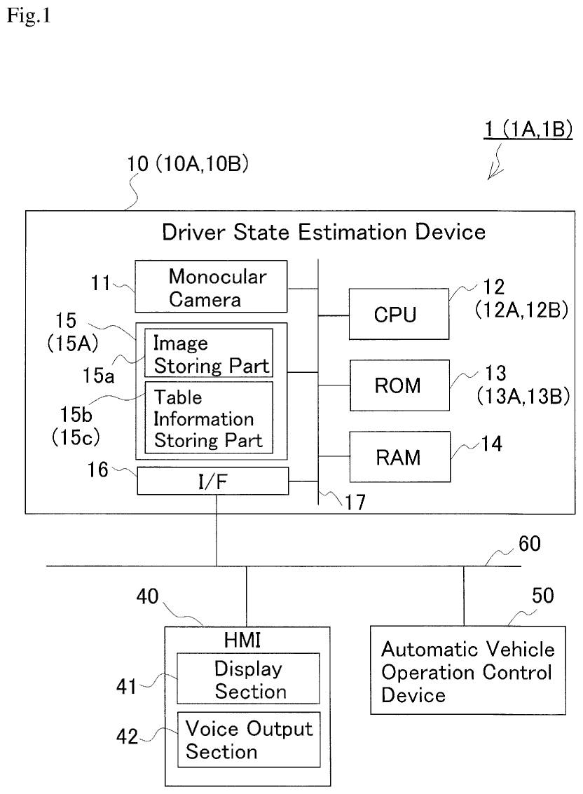

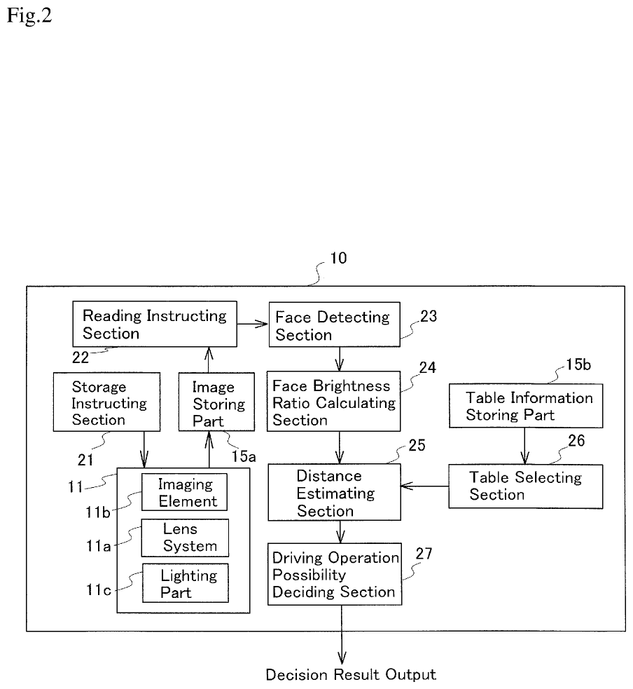

FIG. 1 is a block diagram schematically showing the principal part of an automatic vehicle operation system including a driver state estimation device according to an embodiment (1). FIG. 2 is a block diagram showing a construction of the driver state estimation device according to the embodiment (1).

An automatic vehicle operation system 1 is a system for allowing a vehicle to automatically cruise along a road, comprising a driver state estimation device 10, an HMI (Human Machine Interface) 40, and an automatic vehicle operation control device 50, each of which is connected through a communication bus 60. To the communication bus 60, various kinds of sensors and control devices (not shown) required for controlling an automatic vehicle operation and a manual vehicle operation by a driver are also connected.

The driver state estimation device 10 conducts processing of calculating a brightness ratio between a face of a driver in a first image (hereinafter, also referred to as a lighting-on image) picked up at the time of light irradiation from a lighting part 11c and that in a second image (hereinafter, also referred to as a lighting-off image) picked up at the time of no light irradiation from the lighting part 11c so as to estimate a distance from a monocular camera 11 to a head of the driver with use of the calculated face brightness ratio, processing of deciding whether the driver is in a state of being able to conduct a driving operation based on the estimation result of distance so as to output the decision result, and the like.

The driver state estimation device 10 comprises the monocular camera 11, a CPU 12, a ROM 13, a RAM 14, a storage section 15, and an input/output interface (I/F) 16, each of which is connected through a communication bus 17. Here, the monocular camera 11 may be constructed as a camera unit separately from the device body.

The monocular camera 11 is a camera which can periodically (e.g., 30-60 times/sec) pick up images including the head of the driver sitting in the driver's seat, and comprises a lens system 11a consisting of one or more lenses, an imaging element 11b such as a CCD or a CMOS generating imaging data of a subject, and an analog-to-digital conversion part (not shown) for converting the imaging data to digital data, which constitute an imaging section, and the lighting part 11c comprising an element which irradiates the face of the driver with light, for example, one or more infrared light emitting elements which irradiate near infrared light. On the monocular camera 11, a filter for cutting visible light or a band pass filter for allowing only near infrared range to pass may be mounted.

As the imaging element 11b, an imaging element having sensitivity required for photographing the face both in the visible light range and in the infrared range may be used. When using such element, it becomes possible to photograph the face both with visible light and with infrared light. Here, as a light source of the lighting part 11c, not only an infrared light source but also a visible light source may also be used.

The CPU 12 is a hardware processor, which reads out a program stored in the ROM 13, and based on the program, performs various kinds of processing on image data picked up by the monocular camera 11. A plurality of CPUs 12 may be mounted for every processing such as image processing or control signal output processing.

In the ROM 13, programs for allowing the CPU 12 to perform processing as a storage instructing section 21, a reading instructing section 22, a face detecting section 23, a face brightness ratio calculating section 24, a distance estimating section 25, a table selecting section 26, and a driving operation possibility deciding section 27 shown in FIG. 2, and the like are stored. All or part of the programs performed by the CPU 12 may be stored in the storage section 15 or a storing medium (not shown) other than the ROM 13.

In the RAM 14, data required for various kinds of processing performed by the CPU 12, programs read from the ROM 13, and the like are temporarily stored.

The storage section 15 comprises an image storing part 15a and a table information storing part 15b. In the image storing part 15a, data of images (a lighting-on image and a lighting-off image) picked up by the monocular camera 11 is stored. In the table information storing part 15b, one or more tables for distance estimation showing a correlation of a brightness ratio between the face of the driver in the lighting-on image and the face of the driver in the lighting-off image (a face brightness ratio) with a distance from the head of the driver sitting in the driver's seat to the monocular camera 11 are stored.

In the storage section 15, parameter information including a focal distance, an aperture (an f-number), an angle of view and the number of pixels (width×length) of the monocular camera 11 is stored. And mounting position information of the monocular camera 11 may also be stored. As to the mounting position information of the monocular camera 11, for example, a setting menu of the monocular camera 11 may be constructed in a manner that can be read by the HMI 40, so that at the time of mounting thereof, the setting thereof can be selected in the setting menu. The storage section 15 comprises, for example, one or more non-volatile semiconductor memories such as an EEPROM or a flash memory. The input/output interface (I/F) 16 is used for exchanging data with various kinds of external units through the communication bus 60.

Based on signals sent from the driver state estimation device 10, the HMI 40 performs processing of informing the driver of the state thereof such as a driving attitude, processing of informing the driver of an operational situation of the automatic vehicle operation system 1 or release information of the automatic vehicle operation, processing of outputting an operation signal related to automatic vehicle operation control to the automatic vehicle operation control device 50, and the like. The HMI 40 comprises, for example, a display section 41 mounted at a position easy to be viewed by the driver, a voice output section 42, and an operating section and a voice input section, neither of them shown.

The automatic vehicle operation control device 50 is also connected to a power source control unit, a steering control unit, a braking control unit, a periphery monitoring sensor, a navigation system, a communication unit for communicating with the outside, and the like, none of them shown. Based on information acquired from each of these units, control signals for conducting the automatic vehicle operation are output to each control unit so as to conduct automatic cruise control (such as automatic steering control and automatic speed regulation control) of the vehicle.

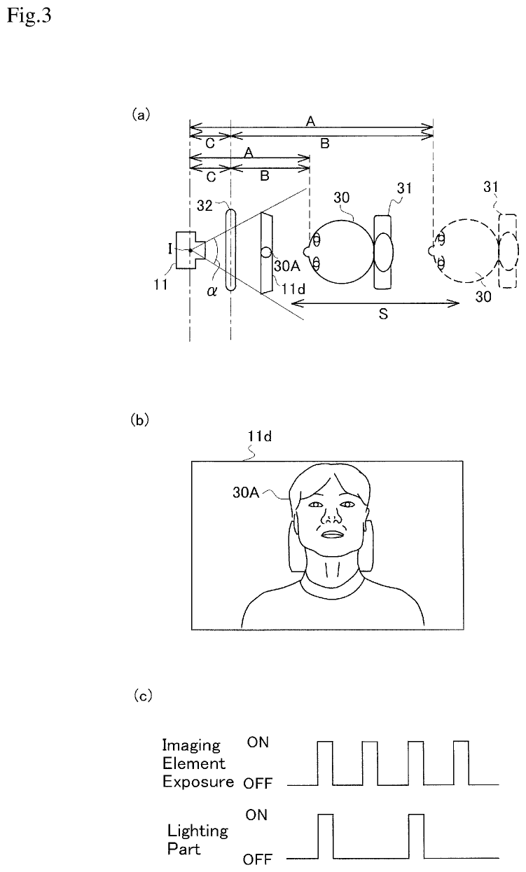

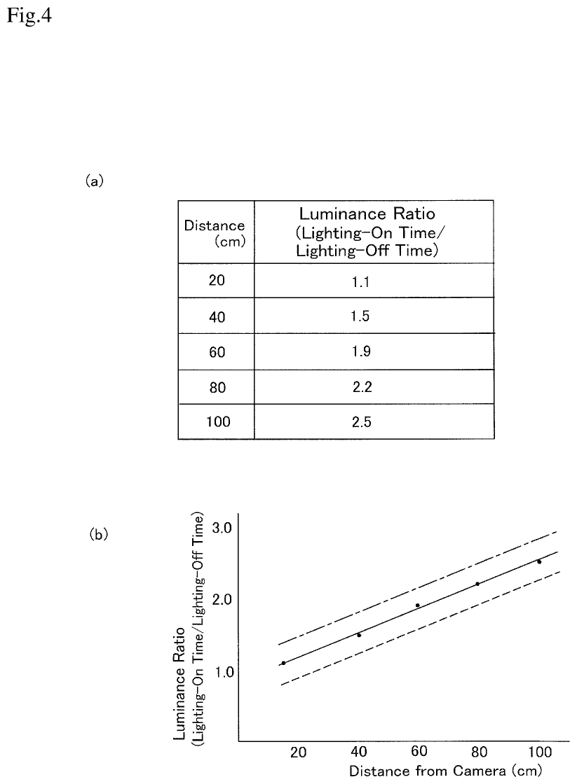

Before explaining each section of the driver state estimation device 10 shown in FIG. 2, the method for estimating the distance to the head of the driver conducted by the driver state estimation device 10 is described below by reference to FIGS. 3 and 4.

FIG. 3(a) is a plan view of a car room showing an installation example of the monocular camera 11, FIG. 3(b) is an illustration showing an image example picked up by the monocular camera 11, and FIG. 3(c) is a timing chart showing an example of picking-up timing of the monocular camera 11 and on/off switching timing of the lighting part 11c.

FIG. 4(a) is a diagram showing an example of a table for distance estimation stored in the table information storing part 15b, and FIG. 4(b) is a graphical representation for explaining some sorts of tables for distance estimation.

As shown in FIG. 3(a), it is a situation in which a driver 30 is sitting in a driver's seat 31. A steering wheel 32 is located in front of the driver's seat 31. The position of the driver's seat 31 can be rearwardly and forwardly adjusted, and the adjustable range of the seat is set to be S. The monocular camera 11 is mounted behind the steering wheel 32 (on a steering column, or at the front of a dashboard or an instrument panel, none of them shown), that is, on a place where images 11d including a head (face) of the driver 30A can be picked up thereby. The mounting position posture of the monocular camera 11 is not limited to this mode.

In FIG. 3(a), a distance from the monocular camera 11 to the driver 30 in the real world is represented by A, a distance from the steering wheel 32 to the driver 30 is represented by B, a distance from the steering wheel 32 to the monocular camera 11 is represented by C, an angle of view of the monocular camera 11 is represented by a, and a center of an imaging plane is represented by I. FIG. 3(b) shows an image example of the driver 30A picked up in a situation where the driver's seat 31 is set in an approximately middle position within the seat adjustable range S.

FIG. 3(c) is a timing chart showing an example of picking-up (exposure) timing of the imaging element 11b of the monocular camera 11 and on/off switching timing of the lighting part 11c. In the example shown in FIG. 3(c), the on and off of lighting by the lighting part 11c are turned every picking-up timing (frame), so that a lighting-on image and a lighting-off image are picked up in turn. However, the on/off switching timing of lighting is not limited to this mode.

FIG. 4(a) is a diagram showing an example of a table for distance estimation stored in the table information storing part 15b, and FIG. 4(b) is a graphical representation for explaining some sorts of tables for distance estimation.

The table for distance estimation shown in FIG. 4(a) shows a correlation of a brightness ratio (luminance ratio) between the face of the driver in a lighting-on image and that in a lighting-off image with a distance from the head of the driver 30 sitting in the driver's seat 31 to the monocular camera 11.

The reflection characteristic of light irradiated from the lighting part 11c varies according to the reflectivity on the face of the driver. In the table information storing part 15b, one or more tables for distance estimation corresponding to different levels of brightness of the face of the driver in the lighting-off image are included.

Generally, the intensity of reflected light has a property of being inversely proportional to the square of the distance (I=k/D², I: Intensity of reflected light, k: Reflection coefficient of an object, D: Distance from the object). With use of this property, it is possible to estimate the distance to the driver using a reflected light image constructed by reflected light. However, the intensity of reflected light is affected by the difference in color (reflection coefficient) of the face of the driver or the difference in skin characteristic (reflection characteristic) of the driver, other than the distance to the driver. Therefore, when only the intensity of reflected light in the reflected light image is referred to, it is difficult to correctly estimate the distance to the driver.

Then, in this embodiment, one or more tables for distance estimation according to the difference in brightness of the faces of persons are previously prepared through learning processing with measured data and the like, and the prepared one or more tables for distance estimation are stored in the table information storing part 15b and used for distance estimation processing. By using a table for distance estimation corresponding to the color (reflection coefficient) of the face or the skin characteristic (reflection characteristic) different driver by driver, it is possible to enhance the estimation accuracy of the distance to the driver.

In order to prepare the tables for distance estimation, with consideration given to the diversity of reflectivity of the faces (skins) of persons, persons having a face (skin) of different reflectivity are selected as sampling models. And under the circumstances similar to the driver's seat of a vehicle, the distance from the monocular camera 11 to the head thereof is set to be, for example, 20, 40, 60, 80, or 100 cm, and at each distance, images are picked up and acquired when the lighting is turned on and off. After detecting each brightness (luminance) of the face (face area) in the acquired lighting-on image and lighting-off image, the luminance ratio is calculated. With use of these items of data, tables for distance estimation are prepared according to every brightness of the face in the image picked up at the time of lighting off.

In FIG. 4(b), a graph indicated with a one-dotted chain line shows an example of the correlation in the case of a high brightness level of the face in the lighting-off image, while a graph indicated with a dashed line shows an example of the correlation in the case of a low brightness level of the face in the lighting-off image.

The higher the brightness level of the face in the lighting-off image becomes, the higher the reflectivity of light from the face at the time of lighting on becomes. On the other hand, the lower the brightness level of the face in the lighting-off image becomes, the lower the reflectivity of light from the face at the time of lighting on becomes. By selecting and using the table for distance estimation corresponding to the brightness of the face of the driver in the lighting-off image (in other words, the reflectivity of light from the face of the driver), it is possible to enhance the accuracy of estimation of the distance A from the monocular camera 11 to the head of the driver 30.

A specific construction of the driver state estimation device 10 according to the embodiment (1) is described below by reference to the block diagram shown in FIG. 2.

The driver state estimation device 10 is established as a device wherein various kinds of programs stored in the ROM 13 are read into the RAM 14 and conducted by the CPU 12, so as to perform processing as the storage instructing section 21, reading instructing section 22, face detecting section 23, face brightness ratio calculating section 24, distance estimating section 25, table selecting section 26, and driving operation possibility deciding section 27. The face detecting section 23, face brightness ratio calculating section 24, distance estimating section 25, and driving operation possibility deciding section 27 may be constructed with a specific chip designed to each of them.

The storage instructing section 21 allows the image storing part 15a which is a part of the storage section 15 to store the data of images (a lighting-on image and a lighting-off image) including the face of the driver 30A picked up by the monocular camera 11. The reading instructing section 22 reads the images (the lighting-on image and lighting-off image) in which the driver 30A is imaged from the image storing part 15a.

The face detecting section 23 detects the face of the driver 30A in the images (the lighting-on image and lighting-off image) read from the image storing part 15a. The method for detecting the face in the images is not particularly limited, and well-known face detecting techniques may be used.

For example, the face may be detected by template matching using a reference template corresponding to the outline of the whole face, or template matching based on the organs (such as eyes, a nose, a mouth and eyebrows) of the face. Or an area close to the color or brightness of the skin is detected, so that the area may be detected as the face. Or as a method for detecting the face at a high speed and with high precision, for example, by regarding a contrast difference (a luminance difference) or edge intensity of local regions of the face, and the relevance (the cooccurrence) between these local regions as feature quantities so as to learn by combining these feature quantities large in number, a detector is prepared. And by a method for image processing using such detector having a hierarchical structure (a hierarchical structure from a hierarchy in which the face is roughly captured to a hierarchy in which the minute portions of the face are captured), the area of the face may be detected. In order to deal with differences in the face direction or inclination, a plurality of detectors which are allowed to learn separately according to face direction or inclination may be mounted.

The face brightness ratio calculating section 24 detects the brightness of the face of the driver in the lighting-on image and the brightness thereof in the lighting-off image, detected by the face detecting section 23, so as to obtain a ratio between the brightness of the face of the driver in the lighting-on image and the brightness thereof in the lighting-off image (face brightness ratio: lighting-on time/lighting-off time). For example, as the face brightness, the luminance (e.g., mean luminance) of the skin region of the face in the image is obtained.

The distance estimating section 25, with use of the face brightness ratio obtained by the face brightness ratio calculating section 24, estimates the distance A from the head of the driver 30 sitting in the driver's seat 31 to the monocular camera 11 (information about the depth).

In order to estimate the distance A, a table for distance estimation selected by the table selecting section 26 is used. The table selecting section 26 selects a table for distance estimation corresponding to the brightness of the face of the driver in the lighting-off image from among one or more tables for distance estimation stored in the table information storing part 15b.

That is, by comparing the face brightness ratio calculated by the face brightness ratio calculating section 24 with the table for distance estimation selected by the table selecting section 26, the distance estimating section 25 estimates the distance A from the head of the driver 30 sitting in the driver's seat 31 to the monocular camera 11.

The driving operation possibility deciding section 27, with use of the distance A estimated by the distance estimating section 25, decides whether the driver 30 is in a state of being able to perform a driving operation. For example, it reads a range in which the driver 30 can reach the steering wheel stored in the ROM 13 or the storage section 15 into the RAM 14 and performs a comparison operation so as to decide whether the driver 30 is within the range of reaching the steering wheel 32. A signal indicating the decision result is output to the HMI 40 and the automatic vehicle operation control device 50. The above decision may be made through subtracting the distance C (the distance from the steering wheel 32 to the monocular camera 11) from the distance A so as to obtain the distance B (the distance from the steering wheel 32 to the driver 30). Here, the information of the distance C may be stored as mounting position information of the monocular camera 11 in the storage section 15.

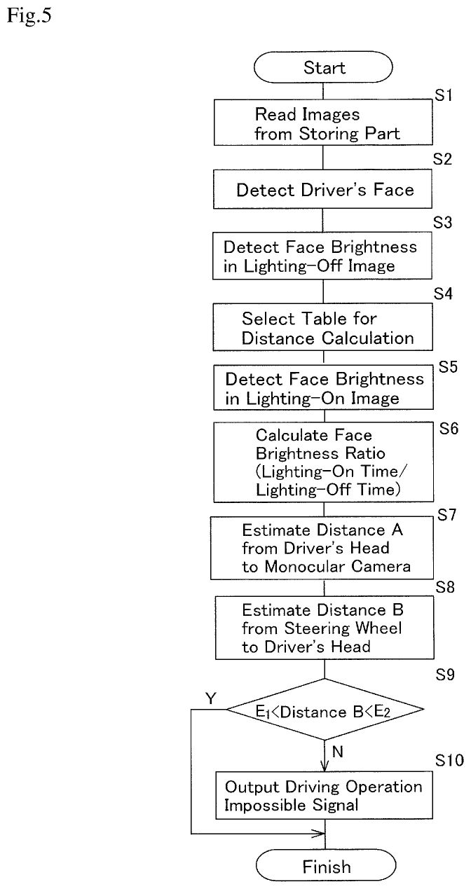

FIG. 5 is a flowchart showing processing operations which the CPU 12 performs in the driver state estimation device 10 according to the embodiment (1). The monocular camera 11 picks up, for example, 30-60 frames of image per second, and with the picking-up timing of each frame, the turning-on/-off of the lighting part 11c is changed. This processing is conducted on every frame or frames at regular intervals.

In step S1, a lighting-on image and a lighting-off image picked up by the monocular camera 11 are read from the image storing part 15a, and in step S2, in each of the read-out lighting-on image and lighting-off image, the face of the driver 30A is detected.

In step S3, the brightness of the face area of the driver 30A in the lighting-off image is detected. As the brightness of the face area, for example, the luminance of the skin region of the face or face organs may be detected.

In step S4, from among the one or more tables for distance estimation stored in the table information storing part 15b, a table for distance estimation corresponding to the brightness of the face of the driver 30A in the lighting-off image detected in step S3 is selected.

In step S5, the brightness of the face of the driver 30A in the lighting-on image is detected. As the brightness of the face area, for example, the luminance of the skin region of the face or face organs may be detected.

In step S6, the ratio (face brightness ratio) between the brightness of the face of the driver 30A in the lighting-on image and that in the lighting-off image is calculated.

In step S7, by fitting the face brightness ratio calculated in step S6 to the table for distance estimation selected in step S4, processing of extracting the distance A from the head of the driver 30 sitting in the driver's seat 31 to the monocular camera 11 (distance estimation processing) is conducted.

In step S8, by subtracting the distance C (distance from the steering wheel 32 to the monocular camera 11) from the distance A estimated in step S7, the distance B (distance from the steering wheel 32 to the driver 30) is obtained.

In step S9, by reading out a range where the driver can appropriately operate the steering wheel stored in the RAM 13 or the storage section 15 so as to conduct a comparison operation, whether the distance B is within the range where the steering wheel can be appropriately operated (distance E₁<distance B<distance E₂) is decided. The distance range from the distance E₁ to the distance E₂ is a distance range where it is estimated that the driver 30 can operate the steering wheel 32 in a state of sitting in the driver's seat 31, and for example, the distances E₁ and E₂ can be set to be about 40 cm and 80 cm, respectively.

In step S9, when it is judged that the distance B is within the range where the steering wheel can be appropriately operated, the processing is ended. On the other hand, when it is judged that the distance B is not within the range where the steering wheel can be appropriately operated, the operation goes to step S10.

In step S10, a driving operation impossible signal is output to the HMI 40 and the automatic vehicle operation control device 50, and thereafter, the processing is ended. The HMI 40, when the driving operation impossible signal is input thereto, for example, performs a display giving an alarm about the driving attitude or seat position on the display section 41, and an announcement giving an alarm about the driving attitude or seat position by the voice output section 42. The automatic vehicle operation control device 50, when the driving operation impossible signal is input thereto, for example, performs speed reduction control.

Using the driver state estimation device 10 according to the embodiment (1), the face of the driver 30A is detected in each of the lighting-on image and the lighting-off image, the brightness ratio between the detected face of the driver 30A in the lighting-on image and that in the lighting-off image is calculated, the calculated face brightness ratio and the table for distance estimation selected by the table selecting section 26 are compared, and the distance A from the head of the driver 30 sitting in the driver's seat 31 to the monocular camera 11 is estimated. Therefore, without obtaining a center position of the face area in the image, the distance A can be estimated based on the brightness ratio between the face of the driver in the lighting-on image and that in the lighting-off image.

Using the driver state estimation device 10, without mounting another sensor in addition to the monocular camera 11, the above-described distance A to the driver can be estimated, leading to a simplification of the device construction. And because of no need to mount the another sensor, additional operations accompanying the mounting thereof are not necessary, leading to a reduction of loads applied to the CPU 12, minimization of the device, and a cost reduction.

By selecting and using the table for distance estimation corresponding to the brightness (reflection characteristic) of the face of the driver, it is possible to enhance the estimation accuracy of the distance from the head of the driver 30 to the monocular camera 11. And by using the table for distance estimation previously stored, the distance A can be speedily estimated without applying a load to the processing.

On the basis of the distance B calculated with use of the distance A estimated by the distance estimating section 25, it is possible to decide whether the driver 30 sitting in the driver's seat 31 is in a state of being able to perform a driving operation, resulting in appropriate monitoring of the driver.

A driver state estimation device 10A according to an embodiment (2) is described below. Here, since the construction of the driver state estimation device 10A according to the embodiment (2) is almost the same as the driver state estimation device 10 shown in FIG. 1 except a CPU 12A, a ROM 13A, and a storage section 15A, the CPU 12A, the ROM 13A, and a table information storing part 15c of the storage section 15A, which are different components, are differently marked and the other components are not described.

In the driver state estimation device 10 according to the embodiment (1), one or more tables for distance estimation according to the levels of the brightness of the face of the driver are stored in the table information storing part 15b, and the table selecting section 26 selects a table for distance estimation corresponding to the brightness of the face of the driver 30A in the lighting-off image.

In the driver state estimation device 10A according to the embodiment (2), one or more tables for distance estimation according to the attributes of the driver are stored in the table information storing part 15c, and a table selecting section 26A selects a table for distance estimation corresponding to the attributes of the driver and the brightness of the face of the driver 30A in the lighting-off image.

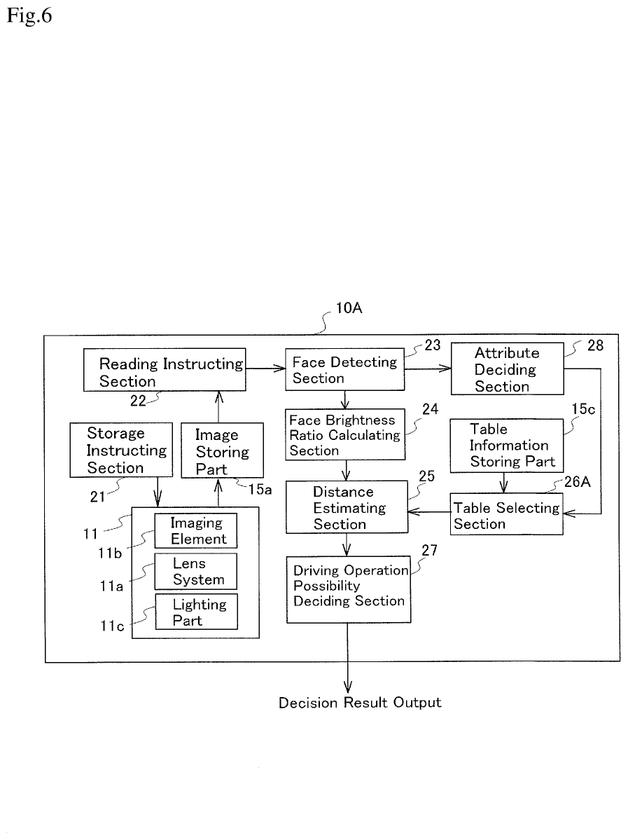

A specific construction of the driver state estimation device 10A according to the embodiment (2) is described below by reference to the block diagram shown in FIG. 6. Here, the components almost the same as those of the driver state estimation device 10 shown in FIG. 2 are similarly marked, and are not described.

The driver state estimation device 10A is established as a device wherein various kinds of programs stored in the ROM 13A are read into a RAM 14 and conducted by the CPU 12A, so as to perform processing as a storage instructing section 21, a reading instructing section 22, a face detecting section 23, a face brightness ratio calculating section 24, a distance estimating section 25, the table selecting section 26A, a driving operation possibility deciding section 27, and an attribute deciding section 28. The face detecting section 23, face brightness ratio calculating section 24, distance estimating section 25, driving operation possibility deciding section 27, and attribute deciding section 28 may be constructed with a specific chip designed to each of them.

The attribute deciding section 28 decides the attributes of the driver using the image of the face of the driver 30A detected by the face detecting section 23.

In the table information storing part 15c, one or more tables for distance estimation corresponding to the attributes of the driver are stored.

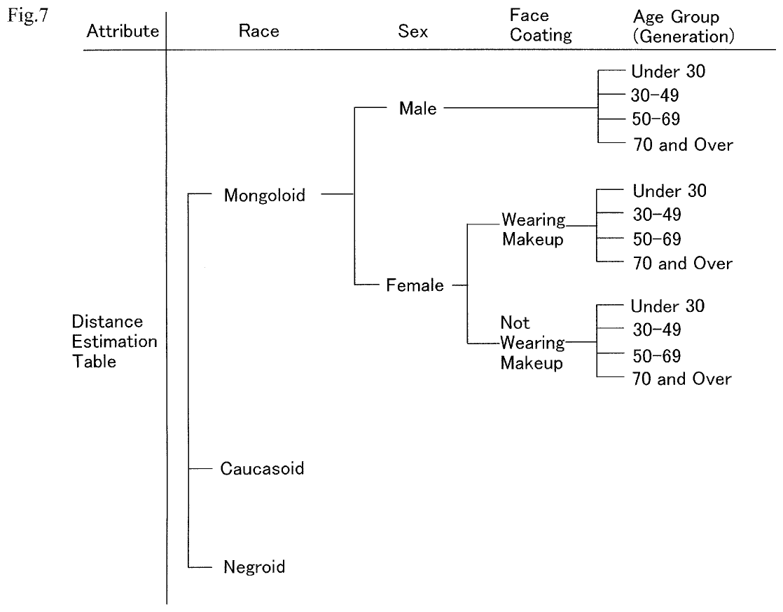

The attributes of the driver decided by the attribute deciding section 28 and the contents of the tables for distance estimation stored in the table information storing part 15c are described below by reference to FIG. 7.

In the attributes of the driver decided by the attribute deciding section 28, the race (e.g., Mongoloid, Caucasoid or Negroid), sex (male or female), face coating (e.g., wearing or not wearing makeup), and age group (e.g., under 30 years old, 30-49 years old, 50-69 years old, 70 years old and over) are included. In the attributes of the driver, at least one of the race, sex, wearing or not wearing makeup, and age may be included.

In the one or more tables for distance estimation stored in the table information storing part 15c, the tables for distance estimation corresponding to the attributes of the driver are included.

That is, as shown in FIG. 7, in the case of the race being Mongoloid, four tables for men and eight tables for women are included. Likewise, in the case of the race being Caucasoid, or Negroid, four tables for men and eight tables for women are included.

The attribute deciding section 28 conducts processing as a race deciding part for deciding the race of the driver, a sex deciding part for deciding the sex thereof, a makeup wearing deciding part for deciding whether the driver is wearing makeup, and an age group deciding part for deciding the age group to which the driver belongs.

And the attribute deciding section 28 conducts processing as a face organ detecting part for detecting organs of the face (e.g., one or more from among eyes, a nose, a mouth, ears, eyebrows, a chin and a forehead) and a feature quantity extracting part for extracting the feature quantity (such as a Haar-like feature including information of the edge direction or intensity of variable density) at a feature point set on each organ detected by the face organ detecting part. To the above face organ detecting part, feature quantity extracting part, race deciding part, sex deciding part, makeup wearing deciding part and age group deciding part, well-known image processing techniques may be applied.

For example, the race deciding part has an identification unit for race pattern recognition on which learning processing using image data groups of each race (Mongoloid, Caucasoid or Negroid) has been previously completed. By inputting the feature quantity at each feature point extracted from the face image of the driver to the identification unit so as to conduct an estimation computation, the race of the driver is decided.

The sex deciding part has an identification unit for sex pattern recognition on which learning processing using image data groups of each sex (male or female) of each race has been previously completed. By inputting the feature quantity at each feature point extracted from the face image of the driver to the identification unit so as to conduct an estimation computation, the sex of the driver is decided.

The makeup wearing deciding part has an identification unit for makeup wearing pattern recognition on which learning processing using image data groups of wearing makeup or not wearing makeup of women of each race has been previously completed. By inputting the feature quantity at each feature point extracted from the face image of the driver to the identification unit so as to conduct an estimation computation, whether the driver (female) is wearing makeup is decided.

The age group deciding part has an identification unit for age group pattern recognition on which learning processing using image data groups of each age group of each sex of each race has been previously completed. By inputting the feature quantity at each feature point extracted from the face image of the driver to the identification unit so as to conduct an estimation computation, the age group of the driver is decided.

The attribute information of the driver decided by the attribute deciding section 28 is sent to the table selecting section 26A.

The table selecting section 26A selects a table for distance estimation corresponding to the attributes of the driver decided by the attribute deciding section 28 and the brightness of the face of the driver 30A in the lighting-off image from the one or more tables for distance estimation stored in the table information storing part 15c.

The distance estimating section 25 compares the face brightness ratio calculated by the face brightness ratio calculating section 24 with the table for distance estimation selected by the table selecting section 26A, so as to estimate the distance A from the head of the driver 30 sitting in the driver's seat 31 to the monocular camera 11.

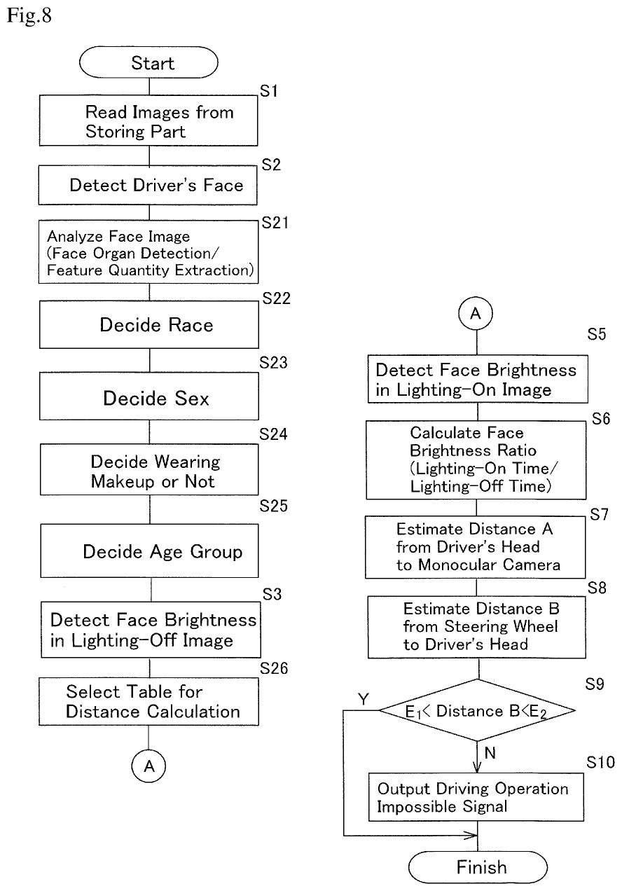

FIG. 8 is a flowchart showing processing operations which the CPU 12A performs in the driver state estimation device 10A according to the embodiment (2). Here, the same processing operations as those in the flowchart shown in FIG. 5 have the same step numbers and are not described.

In step S1, a lighting-on image and a lighting-off image picked up by the monocular camera 11 are read from the image storing part 15a, and in step S2, in each of the read-out lighting-on image and lighting-off image, the face (face area) of the driver 30A is detected. Thereafter, the operation goes to step S21.

In step S21, in order to decide the attributes of the driver, image analysis processing of the face of the driver 30A detected in step S2 is conducted. That is, by the processing of detecting the face organs, the processing of extracting the feature quantity at a feature point set on each organ and the like, an estimation computation of the location of each face organ, bone structure, wrinkle, sag, skin color and the like is conducted.

In step S22, by inputting the feature quantity at each feature point extracted from the face image of the driver 30A analyzed in step S21 to the identification unit for race pattern recognition so as to conduct an estimation computation, the race of the driver is decided. After deciding the race thereof, the operation goes to step S23.

In step S23, by inputting the feature quantity at each feature point extracted from the face image of the driver 30A analyzed in step S21 to the identification unit for sex pattern recognition so as to conduct an estimation computation, the sex of the driver (male or female) is decided. After deciding the sex thereof, the operation goes to step S24.

In step S24, by inputting the feature quantity at each feature point extracted from the face image of the driver 30A analyzed in step S21 to the identification unit for makeup wearing pattern recognition so as to conduct an estimation computation, whether makeup is put on the face of the driver (wearing makeup or not wearing makeup) is decided. After deciding wearing makeup or not, the operation goes to step S25.

In step S25, by inputting the feature quantity at each feature point extracted from the face image of the driver 30A analyzed in step S21 to the identification unit for age group pattern recognition so as to conduct an estimation computation, the age group of the driver is decided. After deciding the age group thereof, the operation goes to step S3.

In step S3, the brightness of the face of the driver 30A in the lighting-off image is detected, and the operation goes to step S26.

In step S26, on the basis of the attributes of the driver decided by the processing operations in steps S22-S25 and the brightness of the face of the driver 30A detected in step S3, a table for distance estimation corresponding thereto is selected from the table information storing part 15c, and the processing operations in step S5 and thereafter are conducted.

Using the driver state estimation device 10A according to the embodiment (2), the attributes of the driver are decided using the image of the face of the driver 30A detected by the face detecting section 23, and the table for distance estimation corresponding to the attributes of the driver decided by the attribute deciding section 28 is selected from one or more tables for distance estimation. Consequently, the table for distance estimation corresponding to not only the brightness of the face of the driver 30A in the lighting-off image but also the attributes of the driver can be selected and used, leading to further enhanced accuracy of the distance A estimated by the distance estimating section 25.

And since at least one of the race, sex, wearing or not wearing makeup, and age is included in the attributes of the driver, tables for distance estimation according to various attributes of the driver can be prepared for selection, leading to further enhanced accuracy of the distance A estimated by the distance estimating section 25.

A driver state estimation device 10B according to an embodiment (3) is described below. Here, since the construction of the driver state estimation device 10B according to the embodiment (3) is similar to that of the driver state estimation device 10 shown in FIG. 1 except a CPU 12B and a ROM 13B, the CPU 12B and the ROM 13B, which are different components, are differently marked and the other components are not described.

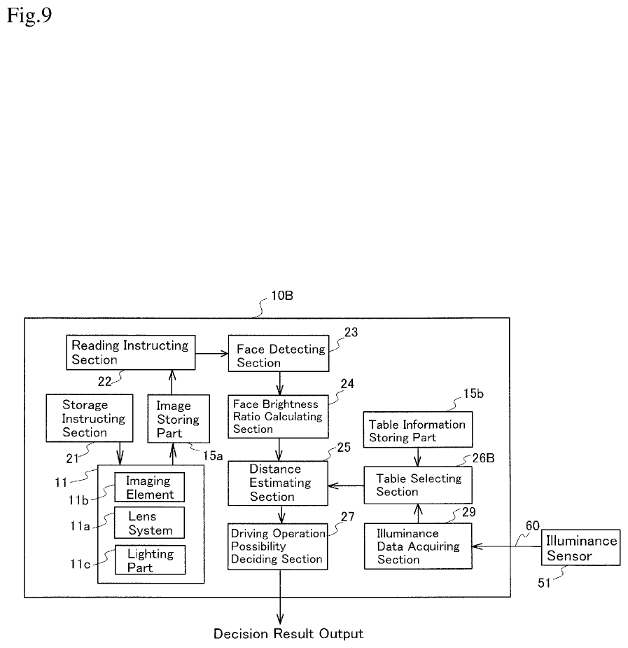

FIG. 9 is a block diagram showing the construction of the driver state estimation device 10B according to the embodiment (3). Here, the components almost the same as those of the driver state estimation device 10 shown in FIG. 2 are similarly marked, and are not described.

The driver state estimation device 10B is established as a device wherein various kinds of programs stored in the ROM 13B are read into a RAM 14 and conducted by the CPU 12B, so as to perform processing as a storage instructing section 21, a reading instructing section 22, a face detecting section 23, a face brightness ratio calculating section 24, a distance estimating section 25, a table selecting section 26B, a driving operation possibility deciding section 27, and an illuminance data acquiring section 29.

A major different point between the driver state estimation device 10B according to the embodiment (3) and the driver state estimation device 10 according to the embodiment (1) is that the CPU 12B has the illuminance data acquiring section 29 for acquiring illuminance data from an illuminance sensor 51 for detecting an illuminance outside the vehicle, so that the table selecting section 26B selects a table for distance estimation corresponding to the brightness of a face of a driver in a lighting-off image in consideration of the illuminance data acquired by the illuminance data acquiring section 29.

The illuminance sensor 51 is a sensor which detects the illuminance outside the vehicle installed on the vehicle (on the body or in the car room), comprising, for example, a light receiving element such as a photodiode, an element which converts received light into an electric current, and the like. The illuminance data acquiring section 29 acquires the illuminance data detected by the illuminance sensor 51 through a communication bus 60.

In the on-vehicle circumstances, there is a possibility that a situation in which the brightness of the face of the driver and the brightness of the surroundings are extremely different might be caused according to the light radiation direction from the sun or the road situation such as the entrance or exit of a tunnel. In such cases, the brightness of the face of the driver in the lighting-off image is affected. For example, in a case where the face of the driver is illuminated by the westering sun, the face of the driver is photographed brightly. On the other hand, in a case where the vehicle entered a tunnel, the face of the driver is photographed dark.

In the case of the driver state estimation device 10B according to the embodiment (3), in step S3 in FIG. 5, using the illuminance data acquired by the illuminance data acquiring section 29 as a brightness change parameter of the face of the driver, the brightness of the face area of the driver in the lighting-off image is detected, and thereafter, the operation goes to step S4, wherein a table for distance estimation corresponding to the brightness of the face of the driver in the lighting-off image is selected.

For example, the value of the brightness of the face of the driver in the lighting-off image is corrected according to the value of the acquired illuminance data, and a table for distance estimation corresponding to the corrected brightness of the face of the driver is selected.

Specifically, in cases where the value of the illuminance data is higher (brighter) than the reference range, the value of the brightness of the face of the driver in the lighting-off image is corrected to be smaller. In cases where the value of the illuminance data is lower (darker) than the reference range, the value of the brightness of the face of the driver is corrected to be larger. Then, a table for distance estimation corresponding to the corrected brightness of the face of the driver is selected.

Using the driver state estimation device 10B according to the embodiment (3), it is possible to select an appropriate table for distance estimation with a consideration given to the illuminance outside the vehicle at the time of picking up the lighting-off image, leading to reduced variations in the accuracy of the distance A estimated by the distance estimating section 25. And by allowing the driver state estimation device 10A according to the embodiment (2) to have the illuminance data acquiring section 29, the same effect can be obtained.

By mounting the driver state estimation device 10, 10A, or 10B according to the above embodiment (1), (2), or (3) on the automatic vehicle operation system 1, 1A, or 1B, respectively, it becomes possible to allow the driver 30 to appropriately monitor the automatic vehicle operation. Even if a situation in which cruising control by automatic vehicle operation is hard to conduct occurs, transfer to manual vehicle operation can be swiftly and safely conducted, resulting in enhanced safety of the automatic vehicle operation system 1, 1A, or 1B.

(Addition 1)

A driver state estimation device for estimating a state of a driver using picked-up images, comprising:

an imaging section for imaging a driver sitting in a driver's seat;

a lighting part for irradiating a face of the driver with light;

at least one storage section; and

at least one hardware processor,

the at least one storage section comprising

an image storing part for storing the image picked up by the imaging section, and

the at least one hardware processor comprising

a storage instructing section for allowing the image storing part to store a first image picked up by the imaging section at the time of light irradiation from the lighting part and a second image picked up by the imaging section at the time of no light irradiation from the lighting part,

a reading instructing section for reading the first image and the second image from the image storing part,

a face detecting section for detecting the face of the driver in the first image and the second image read from the image storing part,

a face brightness ratio calculating section for calculating a brightness ratio between the face of the driver in the first image and the face of the driver in the second image, detected by the face detecting section, and

a distance estimating section for estimating a distance from a head of the driver sitting in the driver's seat to the imaging section with use of the face brightness ratio calculated by the face brightness ratio calculating section.

(Addition 2)

A driver state estimation method for estimating a state of a driver sitting in a driver's seat by using a device comprising

an imaging section for imaging the driver sitting in the driver's seat,

a lighting part for irradiating a face of the driver with light,

at least one storage section, and

at least one hardware processor,

the at least one storage section comprising

an image storing part for storing an image picked up by the imaging section, wherein

the at least one hardware processor conducts the steps comprising:

storage instructing for allowing the image storing part to store a first image picked up by the imaging section at the time of light irradiation on the face of the driver from the lighting part and a second image picked up by the imaging section at the time of no light irradiation on the face of the driver from the lighting part;

reading instructing for reading the first image and the second image from the image storing part;

detecting the face of the driver in the first image and the second image read from the image storing part,

calculating a face brightness ratio between the face of the driver in the first image and the face of the driver in the second image, detected in the step of detecting the face; and

estimating a distance from a head of the driver sitting in the driver's seat to the imaging section with use of the face brightness ratio calculated in the step of calculating the face brightness ratio.

### INDUSTRIAL APPLICABILITY

The present invention may be widely applied to an automatic vehicle operation system in which a state of a driver need be monitored, and the like, chiefly in the field of automobile industry.

### DESCRIPTION OF REFERENCE SIGNS

1, 1A, 1B: Automatic vehicle operation system
10, 10A, 10B: Driver state estimation device
11: Monocular camera
11a: Lens system
11b: Imaging element
11c: Lighting part
11d: Image
12, 12A, 12B: CPU
13, 13A, 13B: ROM
14: RAM
15, 15A: Storage section
15a: Image storing part
15b, 15c: Table information storing part
16: I/F
17: Communication bus
21: Storage instructing section
22: Reading instructing section
23: Face detecting section
24: Face brightness ratio calculating section
25: Distance estimating section
26: Table selecting section
27: Driving operation possibility deciding section
28: Attribute deciding section
29: Illuminance data acquiring section
30, 30A: Driver
31: Driver's seat
32: Steering wheel
40: HMI
50: Automatic vehicle operation control device
51: Illuminance sensor
60: Communication bus

1. A driver state estimation device for estimating a state of a driver using picked-up images, comprising:
an imaging section for imaging a driver sitting in a driver's seat;
a lighting part for irradiating a face of the driver with light;
a table information storing part for storing one or more tables for distance estimation showing a correlation of a brightness ratio between the face of the driver in an image picked up by the imaging section at the time of light irradiation from the lighting part and the face of the driver in an image picked up by the imaging section at the time of no light irradiation from the lighting part with a distance from a head of the driver sitting in the driver's seat to the imaging section; and
at least one hardware processor,
the at least one hardware processor comprising
a face detecting section for detecting the face of the driver in a first image picked up by the imaging section at the time of light irradiation from the lighting part and in a second image picked up by the imaging section at the time of no light irradiation from the lighting part,
a face brightness ratio calculating section for calculating a brightness ratio between the face of the driver in the first image and the face of the driver in the second image, detected by the face detecting section,
a table selecting section for selecting a table for distance estimation corresponding to the brightness of the face of the driver in the second image from the one or more tables for distance estimation stored in the table information storing part, and
a distance estimating section for estimating a distance from the head of the driver sitting in the driver's seat to the imaging section by comparing the face brightness ratio calculated by the face brightness ratio calculating section with the table for distance estimation selected by the table selecting section.

2. (canceled)

3. The driver state estimation device according to claim 1, wherein the at least one hardware processor comprises
an attribute deciding section for deciding attributes of the driver using the image of the face of the driver detected by the face detecting section, wherein
the one or more tables for distance estimation include a table for distance estimation corresponding to the attributes of the driver, and
the table selecting section selects the table for distance estimation corresponding to the attributes of the driver decided by the attribute deciding section from the one or more tables for distance estimation.

4. The driver state estimation device according to claim 3, wherein the attributes of the driver include at least one of the race, sex, wearing or not wearing makeup, and age.

5. The driver state estimation device according to claim 1, wherein the at least one hardware processor comprises
an illuminance data acquiring section for acquiring illuminance data from an illuminance detecting section for detecting an illuminance outside the vehicle, wherein
the table selecting section selects the table for distance estimation corresponding to the brightness of the face of the driver in the second image in consideration of the illuminance data acquired by the illuminance data acquiring section.

6. The driver state estimation device according to claim 1, wherein the at least one hardware processor comprises
a driving operation possibility deciding section for deciding whether the driver sitting in the driver's seat is in a state of being able to conduct a driving operation with use of the distance estimated by the distance estimating section.

7. A driver state estimation method for estimating a state of a driver sitting in a driver's seat by using a device comprising
an imaging section for imaging the driver sitting in the driver's seat,
a lighting part for irradiating a face of the driver with light,
a table information storing part for storing one or more tables for distance estimation showing a correlation of a brightness ratio between the face of the driver in an image picked up by the imaging section at the time of light irradiation from the lighting part and the face of the driver in an image picked up by the imaging section at the time of no light irradiation from the lighting part with a distance from a head of the driver sitting in the driver's seat to the imaging section, and
at least one hardware processor, wherein
the at least one hardware processor conducts the steps comprising:
detecting the face of the driver in a first image picked up by the imaging section at the time of light irradiation on the face of the driver from the lighting part and in a second image picked up by the imaging section at the time of no light irradiation on the face of the driver from the lighting part;
calculating a face brightness ratio between the face of the driver in the first image and the face of the driver in the second image, detected in the step of detecting the face;
selecting a table for distance estimation corresponding to the brightness of the face of the driver in the second image from the one or more tables for distance estimation stored in the table information storing part; and
estimating a distance from the head of the driver sitting in the driver's seat to the imaging section by comparing the face brightness ratio calculated in the step of calculating the face brightness ratio with the table for distance estimation selected in the step of selecting the table.

8. The driver state estimation device according to claim 3, wherein the at least one hardware processor comprises
a driving operation possibility deciding section for deciding whether the driver sitting in the driver's seat is in a state of being able to conduct a driving operation with use of the distance estimated by the distance estimating section.

9. The driver state estimation device according to claim 4, wherein the at least one hardware processor comprises
a driving operation possibility deciding section for deciding whether the driver sitting in the driver's seat is in a state of being able to conduct a driving operation with use of the distance estimated by the distance estimating section.

10. The driver state estimation device according to claim 5, wherein the at least one hardware processor comprises
a driving operation possibility deciding section for deciding whether the driver sitting in the driver's seat is in a state of being able to conduct a driving operation with use of the distance estimated by the distance estimating section.
